(19) United States
(12) Patent Application Publication
(10) Pub. No.: US 2012/0305340 A1
(43) Pub. Date: Dec. 6, 2012

(54) ELEVATOR, FLOOR, AND DOOR ACCESS CONTROL SYSTEM AND METHOD

(76) Inventor: Ming-Yuan WU, Taipei City (TW)

(21) Appl. No.: 13/149,237

(22) Filed: May 31, 2011

(51) Int. Cl. B66B 1/28; G06F 7/04

(52) U.S. Cl. 187/381; 187/380

(57) ABSTRACT

A secure access system and method is disclosed, the access system utilizing a powered secure card with access rights codes that allows an authorized user to gain access to an elevator, an area behind a door, or a particular floor in a building without requiring the user to retrieve the secure card and physically present the secure card to a sensor. Sensors in the access system communicate with a wireless transceiver in the secure card. Each sensor is capable of reading only the type of access code or codes that the sensor has been authorized for reading. A sequence of sensors for allowing or, denying access to areas or functions for the secure card increases security and prevents illicit copying of the access codes and duplication of the secure card.

### BACKGROUND OF THE INVENTION

1. Field of the Invention

The present invention relates to access control systems. More specifically, the present invention discloses a convenient and secure access system utilizing a secure card with access rights codes that allows an authorized user to gain access to an elevator, an area behind a door, or a particular floor in a building without requiring the user to retrieve the secure card.

2. Description of the Prior Art

Keys are typically used to open locked doors in a conventional door access system. The metal key has a pattern cut into an extending portion of the key and when inserted into a lock, if the key pattern is correct for that particular lock, the lock will unlock and the door can be opened.

Similarly, a special key is used to allow certain personnel, such as security officers or VIPs, to use the elevator to access floors in a building that are normally not allowed for others.

However, the conventional key has several disadvantages. If the key is lost the key can be used by others to unlock locks and open doors that the key is associated with. Additionally, since the key and lock are purely mechanical devices they cannot recognize or determine if the user is authorized to utilize that key or access that lock. Furthermore, keys are easily duplicated by unauthorized people.

As a result, the security of the conventional key/lock system is vulnerable to misuse and unauthorized access to areas that are only intended to be accessed by the original key holder.

Moreover, a conventional elevator system allows anyone to press a floor button and access a floor from the elevator regardless of whether or not the person pressing the button is actually authorized to travel to that floor.

Another type of access system utilizes a remote control. A user presses a button on the remote control and a mechanical opener will open or lift a door. While somewhat convenient, the security of this system is easily defeated by sending frequency signals to the opener until the door opens when the predetermined frequency matches. Also, like the key described above, the remote control is easily lost and misused by others since the opener cannot determine whether or not the user of the remote control is authorized to access the area behind the door.

In order to provide at least a minimum level of security an access system was created utilizing radio frequency identification (RFID) cards. The conventional RFID card contains an RFID tag with an identifier. When using the system a user retrieves the RFID card and swipes or holds the card next to a card reader. The card reader reads the identifier in the RFID tag and if the RFID card is determined to be authorized to access the door or elevator controlled by the card reader, the door is opened or the RFID card user is allowed to travel to the requested floor.

However, the security of the conventional RFID card access system is also vulnerable. If lost, the RFID card can be used by anyone that finds the card. The card reader only confirms that the RFID card is authorized to access a door or floor. The card reader cannot determine whether or not the person using the RFID card is authorized.

Additionally, the identifier in the RFID tag of the RFID card is easily readable therefore allowing the card to be duplicated and misused.

Furthermore, like the key, the RFID card must be located and retrieved by the user prior to using the access system. This is not only time consuming but also inconvenient for the user since the RFID card is typically stored in a bag or a pocket containing other objects. Also, once retrieved, the RFID card must be positioned very close to the card reader in order for the card reader to be able to read the identifier in the RFID tag.

For example, if a user keeps an RFID card inside of a bag along with other cards and personal items, the user must open the bag, search through the contents of the bag to locate the card, retrieve the card, hold the card next to the reader, return the card to the bag, close the bag, and select the floor. This process is very inconvenient for the user.

To compound this inconvenience, if the user is carrying a parcel, package, bags of groceries, luggage, etc. and their hands are full, the user must set the items down on the floor in order to perform the RFID card access process. Then, after completion of the process, the user must pick the items back up off the floor. This procedure is not only inconvenient but also strenuous activity that is physically tiring for the user.

Moreover, if the user has certain physical challenges such as blindness or limited body movement, the conventional RFID card access system typically requires a second party to assist the user in gaining access to areas that the user is already authorized to access. Limiting freedom of movement and requiring assistance can have a negative psychological impact on the user.

Therefore, there is need for an improved access system that is extremely convenient for users while providing superior security to areas that only authorized people are allowed to access.

### SUMMARY OF THE INVENTION

To achieve these and other advantages and in order to overcome the disadvantages of the conventional method in accordance with the purpose of the invention as embodied and broadly described herein, the present invention provides a convenient and secure access system utilizing a secure card with access rights codes that allows an authorized user to gain access to an elevator, an area behind a door, or a particular floor in a building without requiring the user to retrieve the secure card.

A user with a secure card comprising elevator and floor access authorization is able to easily use the elevator to travel to the required floor without having to locate, retrieve, or present the secure card.

The elevator and floor access system of the present invention allows an authorized user to simply walk up to the elevator, enter the elevator, and exit the elevator at their floor without physically interacting with the secure card or an elevator control panel.

The secure card comprises a plurality of access codes that authorize the user to access areas or functions controlled by the access system. The access system utilizes a powered secure card with access rights codes that allows an authorized user to gain access to an elevator, an area behind a door, or a particular floor in a building without requiring the user to retrieve the secure card and physically present the secure card to a sensor.

Sensors in the access system communicate with a wireless transceiver in the secure card. Each sensor is capable of reading only the type of access code or codes that the sensor has been authorized for reading. A sequence of sensors for allowing or denying access to areas or functions for the secure card increases security and prevents illicit copying of the access codes and duplication of the secure card.

Individual access codes or certain codes are only read by specific sensors. By selectively allowing individual sensors or function specific sensors to only be capable of reading specific codes purposeful to the sensor, the level of security is increased.

In order to read a specific access code on a secure card the sensor must present the sensor's identification code to the secure card. If the secure card determines that the identification code allows the sensor to read a specific access code the secure card allows the sensor to only read that specific access code that the sensor is authorized to read.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a drawing illustrating a secure card for an access system according to an embodiment of the present invention;

FIGS. 1B-1C are drawings illustrating a secure card and internal components for an access system according to embodiments of the present invention;

FIGS. 2A-2B are drawings illustrating basic elevator mode of the access system according to an embodiment of the present invention;

FIGS. 3A-3E are drawings illustrating a secure elevator and floor access system according to an embodiment of the present invention;

FIG. 4 is drawing illustrating a secure access system with wing sensors according to an embodiment of the present invention;

FIG. 5A is a drawing illustrating a front view of a door access system according to an embodiment of the present invention;

FIG. 5B is a drawing illustrating a side view of a door access system according to an embodiment of the present invention;

FIG. 5C is a drawing illustrating a side view of a door access system with credential panel according to an embodiment of the present invention;

FIG. 5D is a drawing illustrating a side view of a door access system according to an embodiment of the present invention;

FIG. 6 is a drawing illustrating a side view of a door access system according to an embodiment of the present invention; and

FIGS. 7A-7B are drawings illustrating side views of a door access system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

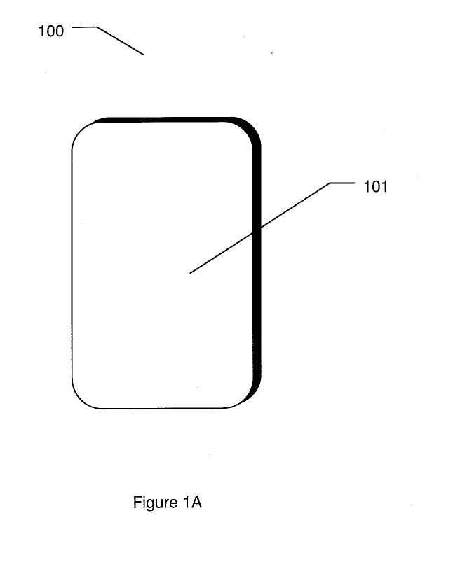

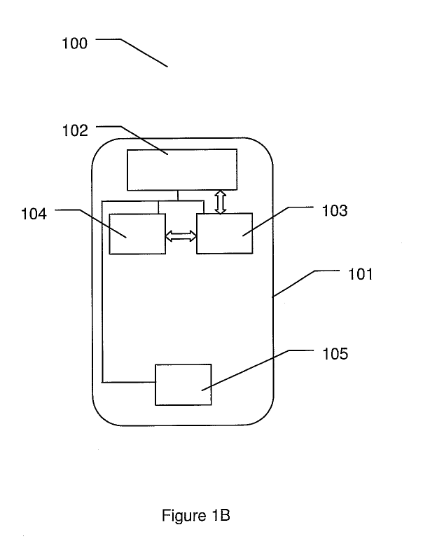

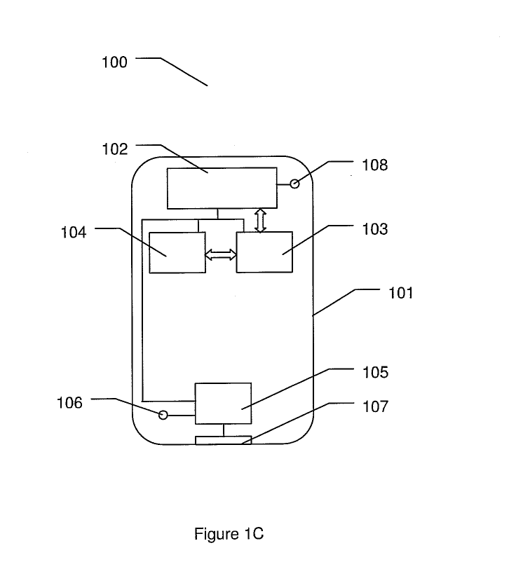

Refer to FIG. 1A, which is a drawing illustrating a secure card for an access system according to an embodiment of the present invention and to FIG. 1B, which is a drawing illustrating a secure card and internal components for an access system according to an embodiment of the present invention.

As shown in FIGS. 1A-1B, a main component of the secure access system of the present invention comprises a secure card 100. The secure card 100 comprises a card housing 101 encasing a wireless transceiver 102, a processor 103, memory 104, and a battery 105.

The card housing 101 comprises a moldable material such as, for example, plastic. The internal components of the secure card 100 are held and protected by the card housing 101. The size of the card housing 101 makes the secure card substantive enough to prevent easy loss yet compact enough to be convenient.

The wireless transceiver 102 comprises a wireless transmitter and a wireless receiver to allow the secure card 100 to communicate with sensors in the secure access system. The wireless transceiver 102 utilizes a wireless communication protocol/technology such as, for example, Bluetooth or Wi-Fi.

The required distance between a sensor and the secure card 100 for detection is selectable by, for example, setting power level for the secure card transceiver and/or the sensor transceiver.

The processor 103 comprises integrated circuitry for performing operations and controlling components of the secure card 100.

Memory 104 is provided for storing data such as, for example, operating system software, access codes, identification codes, data received by the wireless transceiver 102, biometric data, etc.

The secure card 100 of the present invention further comprises a battery 105 for providing power to components of the secure card 100.

In an embodiment of the present invention a section of the card housing 101 is removable so that the battery 105 can be replaced as needed.

In another embodiment of the present invention the card housing 101 does not have a removable section and the battery 105 is recharged using an external power source or the secure card 100 is replaced when the battery 105 is dead.

Alternatively, the battery in the secure card is recharged by a wireless charger that allows secure card users recharge their secure cards by placing them on a special charging pad. The wireless charger uses, for example, inductive charging technology that allows the battery in the secure card to be recharged without the use of cables or adapters.

In an embodiment of the present invention an auxiliary battery is provided for short term use. The auxiliary battery will take over for the main battery when the main battery is dead and until the main battery is replaced or recharged.

Refer to FIG. 1C, which is a drawing illustrating a secure card and internal components for an access system according to an embodiment of the present invention.

In the embodiment of the present invention illustrated in FIG. 1C, the secure card 100 further comprises a low battery indicator 106 for indicating that the battery 105 is low and will soon not be able to supply power to the internal components of the secure card 100. The low battery indicator 106 is, for example, a light emitting diode (LED). The low battery indicator 106 allows a user to ascertain the battery power status.

The secure card 100 further comprises a battery recharge port 107 that allows the secure card 100 to connect to an external power source and recharge the battery 105 without removing the battery 105 from the secure card 100. The battery recharge port 107 is, for example, a USB connector, mini-USB connector, Firewire connector, power adapter connector, or other electrical connector capable of connecting the battery recharge port 107 with the external power source.

For example, to recharge the battery 105 of the secure card 100 a user can plug one end of a cable into the battery recharge port 107 and the other into a connector of a computer, a panel, an electrical outlet, etc.

In the embodiment illustrated in FIG. 1C the secure card 100 further comprises a speaker 108 or buzzer for emitting a sound or vibration. The sound or vibration from the speaker 108 is used, for example, to allow a user to locate the secure card, to indicate low battery power, to indicate status of the secure card 100, to indicate access is granted, etc.

The secure card is an important part of the access system of the present invention. The access system comprises access to an elevator, access to a floor in a building via the elevator, and access to a room or building via a door.

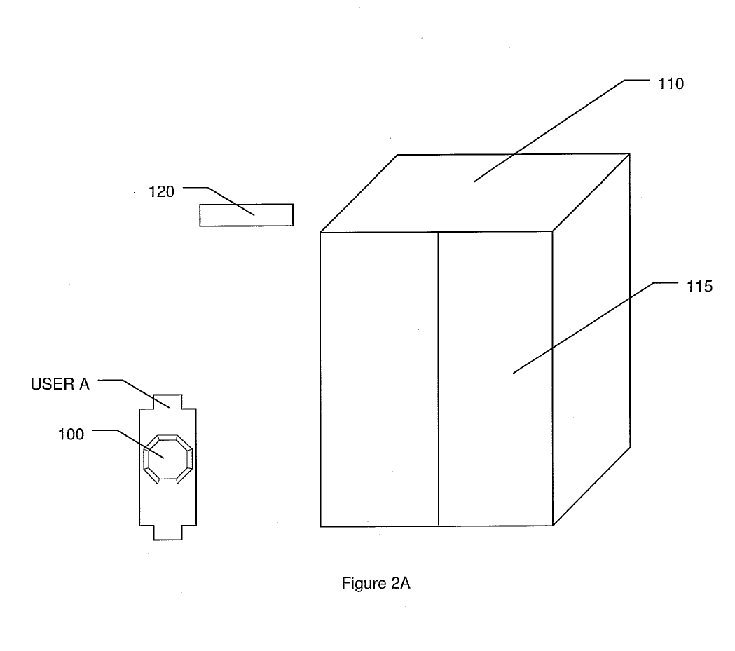

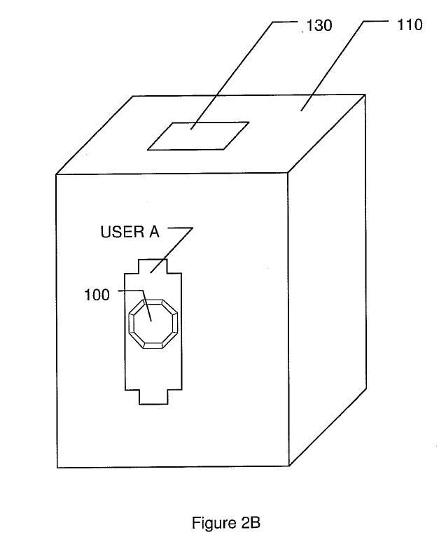

Refer to FIGS. 2A-2B, which are drawings illustrating basic elevator mode of the access system according to an embodiment of the present invention.

As shown in FIG. 2A, USER A walks up to an elevator. As USER A approaches the elevator an elevator exterior sensor 120 detects the secure card 100 of USER A. The secure card 100 can be located, for example, in USER A's pocket, briefcase, purse, bag, or on USER A's person. The elevator exterior sensor 120 and the secure card 100 communicate via the wireless transceiver in the secure card 100 and a wireless transceiver in the elevator exterior sensor 120.

In this communication step the elevator exterior sensor 120 is detecting and determining that the secure card 100 comprises rights for elevator access. For example, the elevator exterior sensor 120 reads an elevator access code stored in memory of the secure card 100 and determines that the secure card 100 has been authorized to use the elevator.

Unlike the conventional RFID card which requires the user to place the RFID card in close proximity (typically within 20 cm) to the RFID card reader, USER A does not need to present the secure card 100 to the elevator exterior sensor 120 in order for the elevator exterior sensor 120 to detect the secure card 100.

The distance between the secure card 100 and the elevator exterior sensor 120 required to detect is selectable according to requirements or designs. For example, in certain applications the secure card is only detected at close proximity such as less than 1 meter. In other applications a greater distance is allowed for convenience.

When the elevator exterior sensor 120 detects the authorized secure card 100 the elevator exterior sensor 120 summons an available elevator car 110. When the elevator car 110 arrives the elevator doors 115 open. USER A with secure card 100 enters the elevator car 110 and the elevator doors 115 close. As shown in FIG. 2B, prior to or after closing of the elevator doors 115 when USER A is inside the elevator car 110 an elevator interior sensor 130 detects USER A's secure card 100. A wireless transceiver in the elevator interior sensor 130 communicates with the wireless transceiver in the secure card 100.

In this communication step the elevator interior sensor 130 is detecting and determining what floor in the building that the secure card 100 comprises rights for access. For example, the elevator interior sensor 130 reads a floor access code stored in memory of the secure card 100 and determines which floor that the secure card 100 has been authorized to access.

The elevator interior sensor 130 signals the elevator controller to select the appropriate floor that the security card 100 has access to and the elevator car 110 travels to the appropriate authorized floor. After arriving at the floor, the elevator doors 115 open and USER A with secure card 100 exit the elevator.

As described, USER A with secure card 100 comprising elevator and floor access authorization is able to easily use the elevator to travel to the required floor without having to locate, retrieve, or present the secure card 100.

The elevator and floor access system of the present invention allows an authorized user to simply walk up to the elevator, enter the elevator, and exit the elevator at their floor without physically interacting with the secure card.

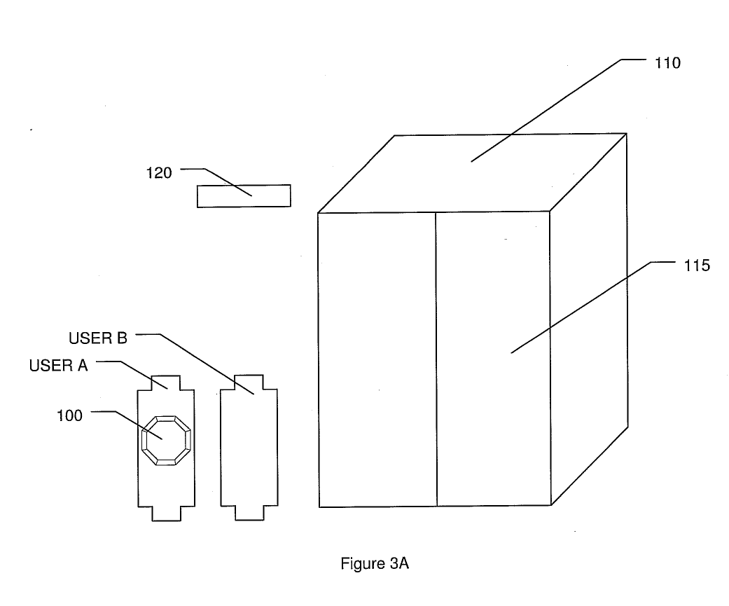

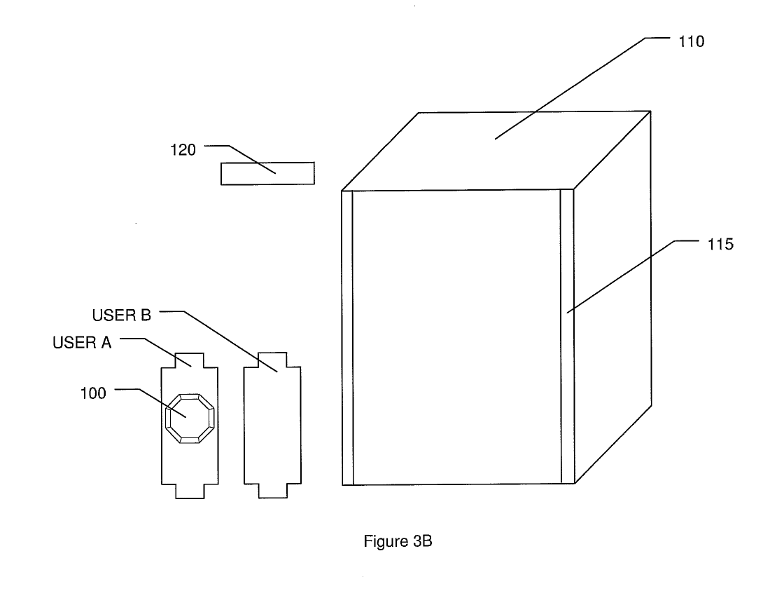

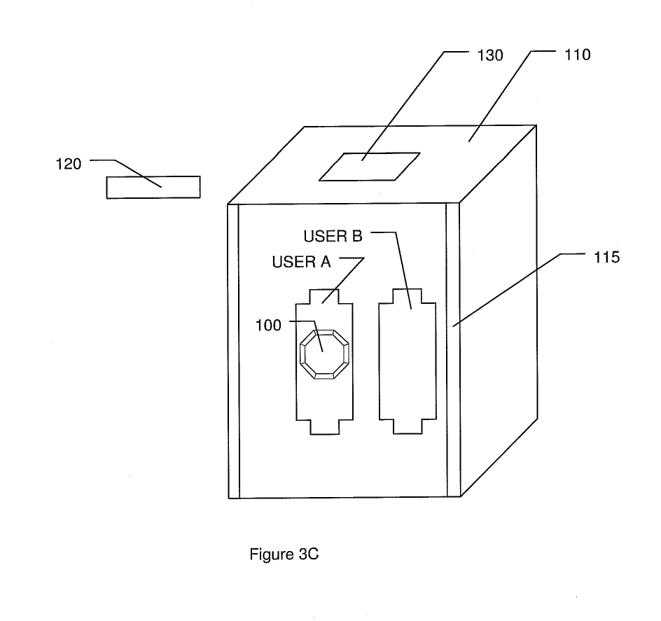

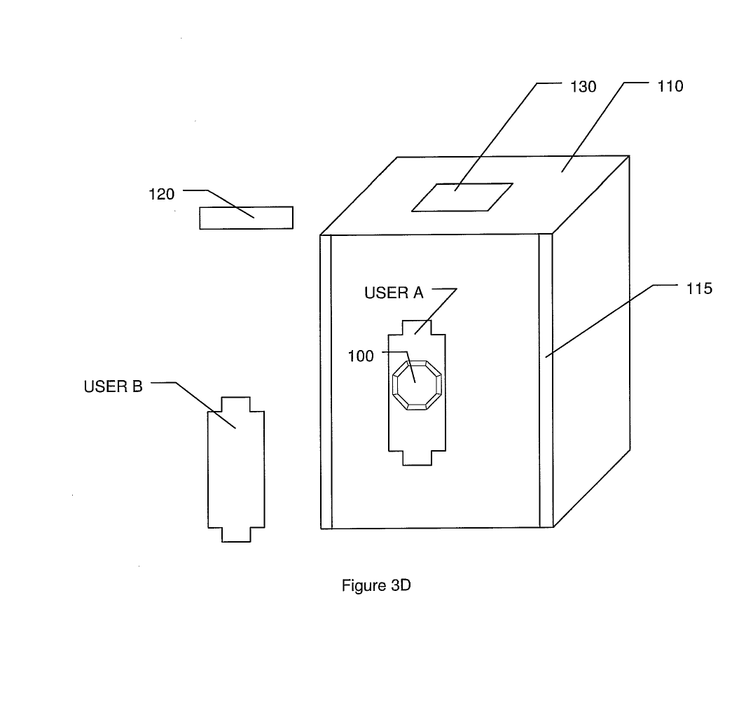

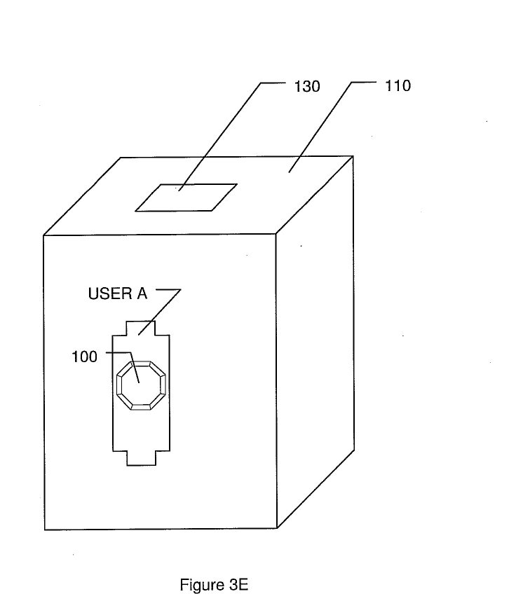

Refer to FIGS. 3A-3E, which are drawings illustrating a secure elevator and floor access system according to an embodiment of the present invention.

As shown in FIG. 3A, both USER A and USER B have approached the elevator. However, USER A has a secure card 100 and USER B does not have a secure card.

The elevator exterior sensor 120 detects USER A's secure card 100 has elevator access rights and summons the elevator car 110.

In FIG. 3B, the summoned elevator car 110 arrives and the elevator doors 115 open.

In FIG. 3C, both USER A with secure card 100 and USER B without secure card enter the elevator car 110.

Prior to or after closing of the elevator doors 115 the elevator interior sensor 130 detects that there are two occupants (USER A and USER B) but there is only one secure card 100 (USER A's) detected.

In order to detect the number of occupants in the elevator car 110 the elevator interior sensor 130 comprises, for example, an infrared sensor, a heat sensor, a motion detecting sensor, a camera, recognition software, etc.

In this situation where there are more occupants than secure cards, the elevator car 110 will not move. Any occupants without secure cards are notified that they must exit the elevator car 110. They are notified by, for example, a buzzer, an alarm, a light, or a display.

If an occupant without a secure card refuses to exit the elevator car, the access system will notify security and the person can be interrogated.

In FIG. 3D, since USER B does not have a secure card USER B exits the elevator car 110 leaving USER A with secure card 100 inside the elevator car 110.

In FIG. 3E, the elevator interior sensor 130 determines that there is one occupant (USER A) and one secure card 100 (USER A'S) in the elevator car 110.

The elevator doors close and the elevator interior sensor 130 wirelessly communicates with the secure card 100 and reads a floor access code that USER A's card has been authorized access. The authorized floor is automatically selected and the elevator car 110 travels to the appropriate floor, the elevator doors open, and USER A with secure card exits.

In this way, only authorized users with secure card comprising elevator access rights are allowed to use the elevator and unauthorized users are prevented from accessing the elevator.

In an embodiment of the present invention the elevator interior sensor 130 also detects an identification code stored in the secure card 100 that uniquely identifies the user of the secure card 100. As a result, no two secure cards with identical identification codes are granted access and the elevator car will not move. This eliminates the possibility or usefulness of attempting to copy a secure card.

Visitors to the facility that do not have a secure card with access authorization can obtain a temporary secure card from the security or guard station at the entrance. The temporary secure card is limited by, for example, which floor or room that the visitor can access. The visitor returns the temporary card when leaving the facility.

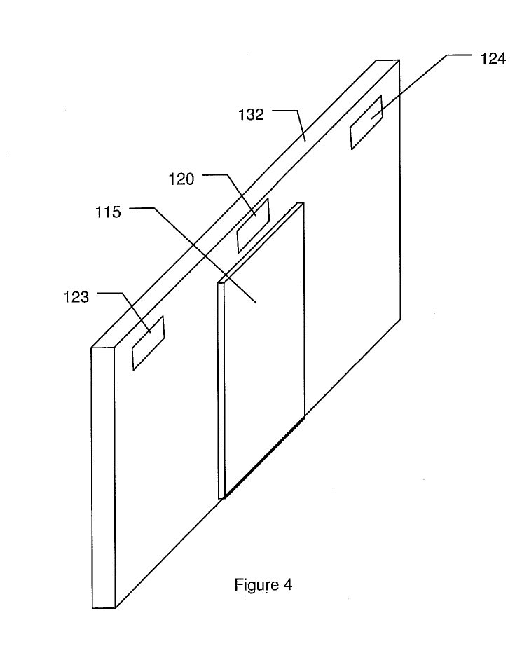

Refer to FIG. 4, which is drawing illustrating a secure access system with wing sensors according to an embodiment of the present invention.

As shown in FIG. 4, the secure access system of the present invention further comprises wing sensors 123 124 positioned in the hallway 132 of a floor. A right wing sensor 123 is located in an area of the hallway 132 to a side of the elevator and a left wing sensor 124 is located in an area of the hallway 132 to the other side of the elevator.

After a user exits the elevator either the right wing sensor 123 or the left wing sensor 124 will detect the user's secure card and the wing sensor will read the wing access rights code of the secure card. If the wing sensor determines that the user's secure card does not have access rights to that particular wing of the building, a signal or alarm is triggered and notifies the user and/or security that the secure card is not authorized to enter that wing. This further increases the level of security of the access system of the present invention.

Additionally, in an embodiment of the present invention if the wing sensor's alarm is triggered all door access sensors are automatically suspended or shut off thereby preventing attempt to access doors in an unauthorized, wing.

In embodiments of the present invention additional sensors are positioned in various locations throughout a building or facility in order to further restrict or require access to different areas. Each sensor detects if the user with the secure card has authorization to be in that location or access that area.

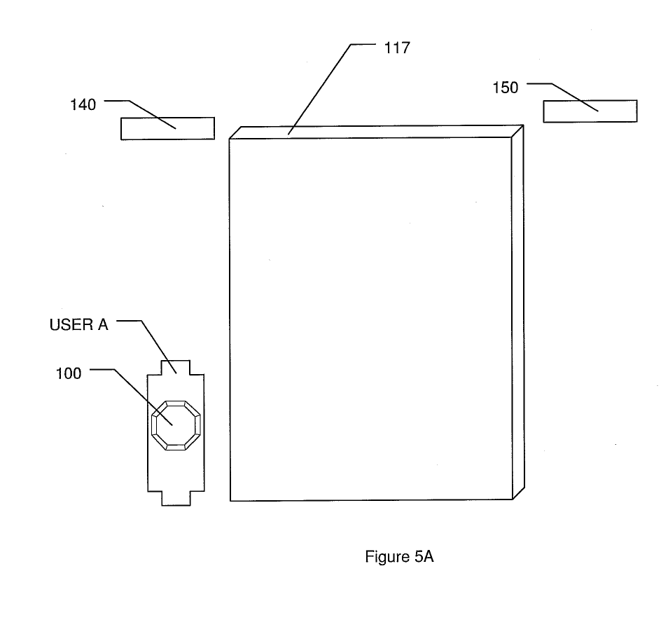

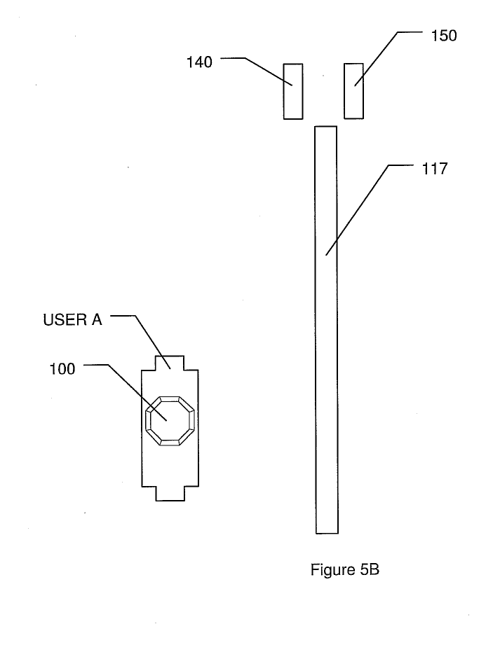

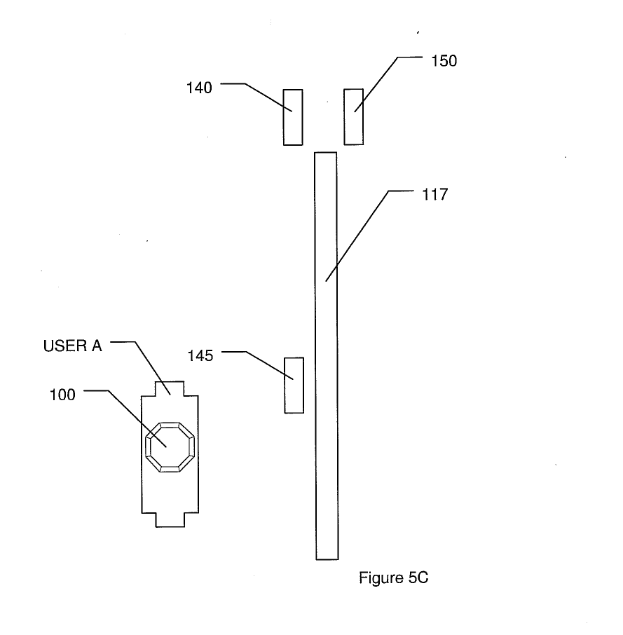

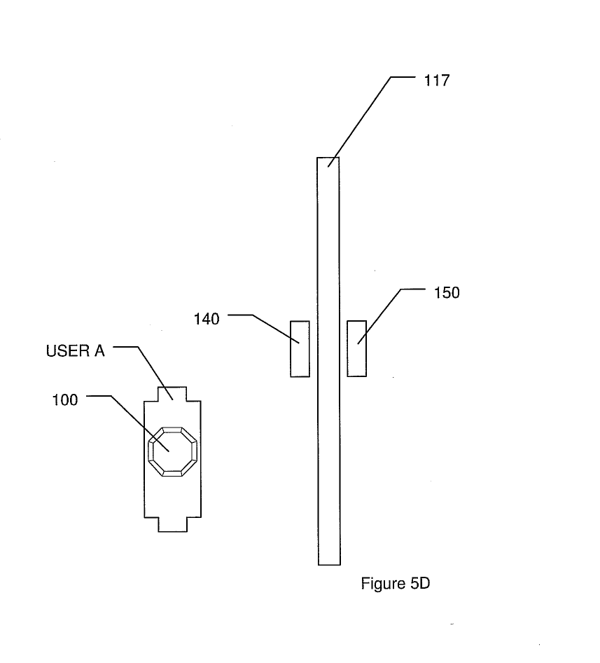

Refer to FIG. 5A, which is a drawing illustrating a front view of a door access system according to an embodiment of the present invention and to FIG. 5B, which is a drawing illustrating a side view of a door access system according to an embodiment of the present invention.

As shown in FIGS. 5A-5B, the door access system of the present invention comprises a door exterior sensor 140, a door interior sensor 150, and a door 117 to a room, house, apartment, or other area.

As shown in FIGS. 5A-5B, USER A walks up to the door 117. As USER A approaches the door the door exterior sensor 140 detects the secure card 100 of USER A. The door exterior sensor 140 and the secure card 100 communicate via the wireless transceiver in the secure card 100 and a wireless transceiver in the door exterior sensor 140.

In this communication step the door exterior sensor 140 is detecting and determining that the secure card 100 comprises rights for door access. For example, the door exterior sensor 140 reads a door access code stored in memory of the secure card 100 and determines that the secure card 100 has been authorized to use this door.

The proximity required for the secure card 100 to be within the door exterior sensor is selectable based on requirements or designs. For example, the proximity can be set to require the secure card to be relatively close to the door/door exterior sensor to be detected in order to eliminate detection of secure cards passing by.

In an embodiment of the present invention when the door exterior sensor 140 determines that the user with secure card 100 has authorization to access the door 117 and the door 117 will open or the locking mechanism of the door will unlock.

In another embodiment of the present invention, the door access system comprises additional security means such as locks that need to be accessed prior to opening of the door.

In an embodiment of the present invention after the user with authorized secure card has opened the door and entered the room the door interior sensor 150 detects the secure card 100. This allows the access system to provide additional features such as, for example, automatically locking the door after closing, turning on lights, recording time or user's presence, activating or deactivating exterior or interior security systems, etc. Additionally, these additional features can be provided upon determination of proper authorization by the door exterior sensor 140.

Refer to FIG. 5C, which is a drawing illustrating a side view of a door access system with credential panel according to an embodiment of the present invention.

As shown if FIG. 5C, the door access system of the present invention comprises a credential panel 145 for receiving a user's credentials. The user's credentials comprise, for example, biometric data such as fingerprint, iris scan, vein scan, password, personal identification number, etc.

In addition to possessing a secure card comprising rights to access to the door the user must also supply a credential or a plurality of credentials in order to access the door.

For example, after the door exterior sensor 140 has determined that the secure card is authorized to access the door, the user supplies a biometric such as a fingerprint to the credential panel 145. In order for the user to be granted access to the door both the secure card must be authorized and the identity of the user from the biometric data must be confirmed. This provides a further level of security for the access system of the present invention.

In an embodiment of the present invention the secure card comprises a user's biometric data stored in the secure card. When a user presents a biometric input to the credential panel the credential panel reads the stored biometric data in the secure card and compares the stored data with the input biometric data. Only if the stored data and the input data match is authentication and authorization granted.

This comparing of stored biometric data with input biometric data prevents an authorized person from using a different authorized person's secure card. For example, both John and Bill are authorized to access this room but John cannot use Bill's secure card to open the door. This prevents fraud since even though the user is authorized access they must use their own secure card.

Refer to FIG. 5D, which is a drawing illustrating a side view of a door access system according to an embodiment of the present invention.

In the embodiment illustrated in FIG. 5D the door exterior sensor 140 and the door interior sensor 150 are positioned at the side of the door 117 rather than at the top of the door 117.

In other embodiments of the present invention the various sensors of the access system are located in various positions or locations depending on requirements, purpose, use, or need.

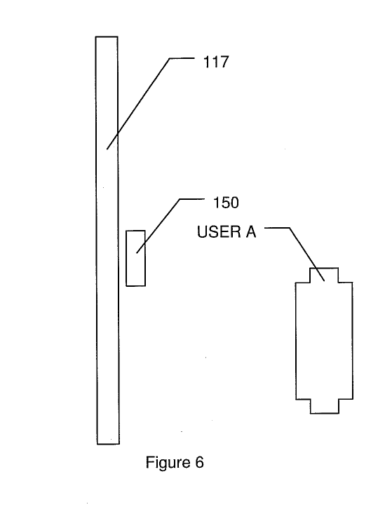

Refer to FIG. 6, which is a drawing illustrating a side view of a door access system according to an embodiment of the present invention.

In the embodiment illustrated in FIG. 6, the door access system comprises a door interior sensor 150. The door interior sensor 150 comprises a sensor that detects when a person is in close proximity to the door 117. As the person approaches the door 117 or opens the door 117 the door interior sensor 150 senses that the detected person does not have an authorized secure card. The door interior sensor 150 will alert the person to the fact that they are leaving without their secure card. For example, a light will illuminate, an audible signal/alarm will sound, etc. to notify the person. The user can then retrieve their secure card and then exit normally when the door interior sensor 150 detects the person and the secure card together.

By notifying the user that they do not have their secure card the user is prevented from getting locked outside without their secure card.

In certain applications the door will automatically lock after a person exits. However, in an embodiment of the present invention in addition to alerting the person that they do not have their secure card, the door will remain unlocked after closing. For example, if the user wants to make a temporary exit and will immediately return the user can exit and the door will automatically remain unlocked until the user returns or remain unlocked for a predetermined time period before locking.

In an embodiment of the present invention the door interior sensor 150 further comprises a locate button. When a user presses the locate button the door interior sensor 150 will attempt to detect the secure card. Upon detection the door interior sensor 150 will instruct the secure card to emit a signal so the user can find the secure card. For example, the secure card will emit a signal comprising an audio sound, beep, alarm, or a light on the card will illuminate. This signal allows the user to easily locate a misplaced or missing secure card.

If not directly powered by the room's electrical power, the door interior sensor has a built in charger so the door interior sensor can be easily removed from the wall and plugged into an electrical socket for recharging.

Additionally, the secure card can be plugged into a power socket on the door interior sensor to recharge the secure card battery.

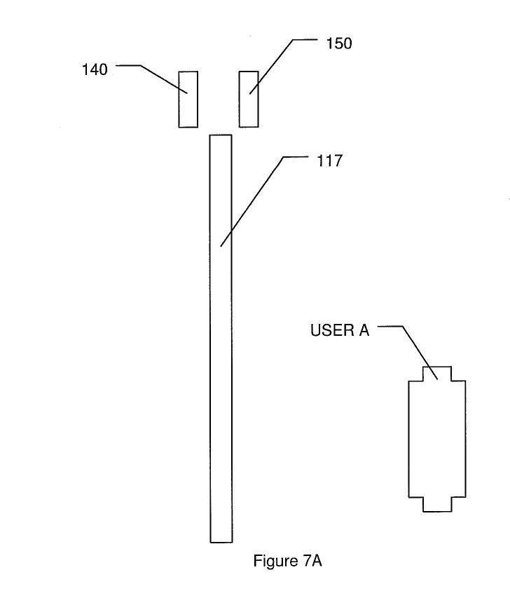

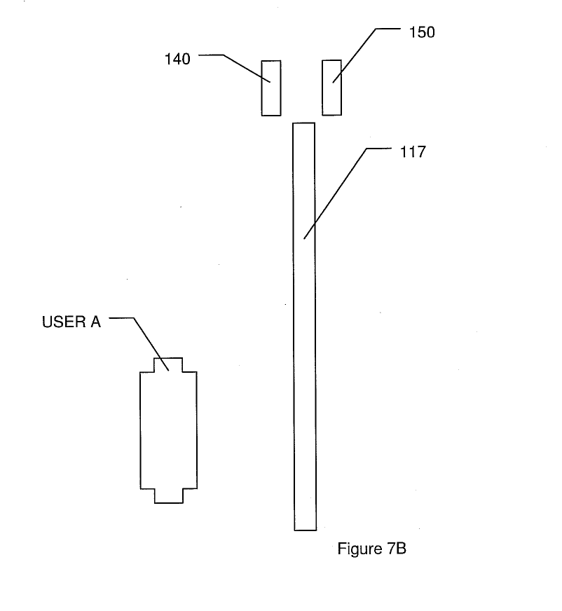

Refer to FIGS. 7A-7B, which are drawings illustrating side views of a door access system according to an embodiment of the present invention.

In the embodiment illustrated in FIGS. 7A-7B the door interior sensor 150 and the door exterior sensor 140 cooperate to provide a detection and notification system when a user exits or attempts to exit a door 117 without their secure card.

In FIG. 7A, the user (USER A) approaches the door 117 and is detected by the interior door sensor 150. The interior door sensor 150 also senses that a secure card has not been detected.

In FIG. 7B, USER A has exited without a secure card and the exterior door sensor detects USER A but doesn't detect a secure card. Either or both of the door sensors will notify USER A that they have forgotten their secure card and the door 117 will remain unlocked. USER A can easily reenter via the door 117 to retrieve their secure card.

In embodiments of the present invention various access codes are stored in memory of the secure card. These access codes provide authorization or rights to access various areas or functions in the access system of the present invention.

In embodiments of the present invention individual access codes or certain codes are only read by specific sensors.

For example, in some applications the elevator external sensor only reads the elevator access code and does not read the door access code. By selectively allowing individual sensors or function specific sensors to only be capable of reading specific codes purposeful to the sensor, the level of security is increased.

For example, the door access code cannot be read unless in close proximity to a specific door. This eliminates the possibility of access codes being read and copied outside of their intended area of use.

In some embodiments of the present invention each sensor comprises a sensor identification code.

In order to read a specific access code on a secure card the sensor must present the sensor's identification code to the secure card. If the secure card determines that the identification code allows the sensor to read a specific access code the secure card allows the sensor to only read that specific access code that the sensor is authorized to read.

For example, elevator interior sensor #4 is authorized to read floor access codes for certain users. Elevator interior sensor #4 sends a read request for floor access code with elevator interior sensor #4's identification code to User A's secure card. User A's secure card verifies that the identification code of elevator interior sensor #4 is among the authorized elevator interior sensors allowed to read the floor access code in User A's secure card. User A's secure card then supplies User A's floor access code to elevator interior sensor #4 or allows elevator interior sensor #4 to read User A's floor access code. If elevator interior sensor #4 is not authorized by the secure card, elevator interior sensor #4 cannot read the access code.

In some embodiments of the present invention certain sensors will request access and read a plurality of access codes. For example, a sensor in a highly secure area can read multiple access codes to verify authorization. In a basic example, a door sensor reads not only the door access code but the floor, wing, building access code, or a combination of these.

Following is a listing of various access codes stored in the secure card and their functions:
Elevator access code—allows access to use the elevator.
Floor specific code—allows access to only be granted for specific floor(s). For example, floor 15 is allowed and all other floors are not allowed access or floors 15-17 are allowed and all other floors are not allowed.
Door specific code—allows access to a specific room or rooms. For example, room 2123 is allowed and all other rooms are not allowed or rooms 2123-2133 are allowed and all other rooms are not allowed.
Site specific code—allows access to buildings on a specific site. For example, all buildings at North Campus Site but buildings at South Campus Site are not allowed.
Building specific code—allows access to a specific building or buildings. For example, building 2 is allowed, buildings 1, 3-6 are not allowed.
Wing specific code—allows access to specific wings of a building (right or left from the elevator). For example, East wing is allowed, West wing is not allowed.
User specific code—secure card user identification, each user/card holder has a unique code. For example, Mr. Smith 12345, Mrs. Smith 12356, Mr. Martin 14328, etc.
Company specific code—allows access to a specific company or companies in a building. For example, ABC Electronics is allowed, POP Optics is not allowed.
Rights/Authorization specific code—access is allowed or prevented by authorization level. For example, supervisor floors 1-5 all rooms allowed, accountant floor 3 room 212 only.
Time specific code—allows access based on hours or time. For example, an office worker can only get access during their shift hours (i.e. 8 am-5 pm), outside these hours access not allowed, CEO allowed access at any time.
Time duration code—access only granted for specific time duration. For example, a visitor is issued a temporary secure card with access rights lasting only 2 hours, after time expires secure card cannot be used to gain access.
Day specific code—allows access to only be granted for specific days. For example, Monday and Tuesday are allowed, Wednesday through Sunday access is not allowed.
Date specific code—access is only granted for a specific date. For example, Mar. 10, 2011 is allowed and every other date access is denied or Mar. 10-13, 2013 is allowed and every other date access is denied.
Sensor specific type code—access to read a specific access code in the secure card is only allowed to specific types of sensors. For example, only door exterior sensors can read door access codes and all other sensors cannot.
Sensor specific identification code—access to read a specific access code in the secure card is only allowed to specific sensors. For example, only door exterior sensor #12 can read the door access code for User A and all other sensors cannot.

In order to eliminate the possibility of secure card duplication the access system of the present invention further comprises secure card copy detection.

In an embodiment of the present invention if user A and user B are waiting for the elevator, the elevator exterior sensor will detect that user A's and user B's user specific codes are the same and the elevator car would not be signaled until user B left the area. Alternatively, the elevator car is summoned but the elevator doors will not close until user B has left the area.

In an embodiment of the present invention if user A has already entered the elevator car and user B runs up and jumps inside the elevator car while the door is closing, after the elevator door closes the elevator interior sensor reads the elevator user specific code before reading the floor access code. If two unique user specific access codes are the same, the system detects copy fraud and notifies security and the elevator car will not move until the violator exits the elevator car.

Since the access codes of each secure card are unique and encrypted, even if user B managed to read and copy user A's elevator access code and/or user A's user access code, in order to read user A's floor access code user A and user B must be in the elevator at the same time. The elevator interior sensor will detect that user A's and user B's elevator access code and/or user access code are the same. The elevator will not move and user B is automatically discovered as attempting to copy card access codes.

In an embodiment of the present invention the access system further detects attempts to copy multiple secure card user's access codes.

For example, user B reads and copies user A's elevator access code and then thinks to copy user A's wife's floor access code in order to bypass the copy detect security. The access system detects that user A's elevator access code and user A's wife's floor access code don't match and denies access to user B. Even though user A and user A's wife live in the same house, their access codes are unique and different. As with all security systems common sense and suspicion add additional safeguards to the access system. For example, user A would notice and be alerted if, in order to read and copy user A's secure card access codes, user B followed user A's path next to him numerous times in order to read all access codes. User A would notify security after the first couple of occurrences. However, the card copy detect features described above would catch user B first.

In an embodiment of the present invention the access system provides for users that are not capable of carrying a secure card or for users that shouldn't be attempting access by themselves. For example, if the user has a pet a small secure card can be placed on the pet's collar. However, if the user does not want the pet to travel independently the pet would not have the secure card. Also, for a user with a baby or small child the user would probably not want to have the child roam independently.

In order to accommodate this situation an embodiment of the present invention provides a solution. If a user with a secure card enters the elevator with a small child or pet the elevator interior sensor will detect two people and one secure card. In order to overcome this the user registers with security and is issued a secure card with access rights for plus 1. When various sensors detect two people but the secure card is registered for two people and has access codes allowing an extra person access is allowed.

Additionally, sensors can be positioned to only allow plus 1 options and access for only very small beings and not adults. For example, user A has a plus 1 secure card but an attempt to bring in a “full size” person along with user A will be denied. In order to further increase the level of security of the access system an embodiment of the present invention further comprises a system of reading one of a plurality of authorized codes of a particular access code type.

For example, the secure card comprises a plurality of door access codes that are all for a specific door. In this embodiment the door exterior sensor reads one of the authorized door access code. Which one of the plurality of door access codes the door exterior sensor reads is determined by the access system. For example, read door access code 32 on Tuesday, code 21 at building 4, etc.

In an embodiment of the present invention the access system can shutdown or turn off access rights for a secure card.

If the secure card is reported lost the system will prevent anyone from using the secure card by denying access to any areas controlled by the access system.

If the user notifies the system that they will be on vacation the system will deny access to anyone trying to use the secure card until the vacation is over.

If a user attempts to access unauthorized areas the system will shut down the access privileges for that secure card after a predetermined number of fraudulent attempts.

Since some users are authorized to access a plurality of floors some embodiments of the present invention provide a bypass or override system.

If the user is authorized to access multiple floors and the elevator selects a certain floor but the user wants to go to another floor, the auto-selected floor is bypassed by pressing the desired floor button.

For example, the elevator interior sensor auto-selects floor 8 but user A wants to go to floor 12. User A presses the “12” button on a panel in the elevator. Floor 12 is then selected and floor 8 is removed. The elevator interior sensor knows that user A is the person that pressed floor 12 because user A's card is closest to the panel.

In some embodiments the access system comprises a voice recognition system that allows the user to speak the desired floor and the system recognizes the voice and selects the spoken floor for that user if the user is authorized to access that floor.

Additionally, if the elevator auto-selects a first floor according to the secure card and the user wants to go to another floor, the user speaks the desired floor, the voice is recognized, the first selected floor is canceled and the spoken new floor is selected.

In some embodiments of the present invention the access system provides an auto-select prediction system in which a user's activity history is recorded and used to predict the most likely floor for auto-selection.

For example, user A is authorized for floors 2-5. In the morning user A usually goes to his office on floor 2 first. Therefore, in the morning floor 2 will be auto-selected for user A. Or user A goes to “floor 2” 90% of the time and “floor 5” 6% of the time. Therefore the system will auto-select floor 2 as it is the most common or likely for user A.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An access control system comprising:
a powered secure card comprising a plurality of stored access codes;
an elevator exterior sensor for detecting the powered secure card, for reading an elevator access code from the powered secure card, and for summoning an elevator car if the elevator access code is authorized; and
an elevator interior sensor inside the elevator car for reading a floor access code from the powered secure card and for instructing the elevator car to travel to a floor represented by the floor access code if the floor access code is authorized.

2. The access control system of claim 1, the elevator interior sensor also detecting how many occupants are in the elevator car.

3. The access control system of claim 1, the elevator interior sensor determining if a number of occupants equals a number of powered secure cards and if the number of occupants is more than the number of powered secure cards instructing the elevator car to remain stationary.

4. The access control system of claim 1, further comprising:
a door exterior sensor for detecting the powered secure card, for reading a door access code stored in the powered secured card, and for allowing access to a door controlled by the door exterior sensor if the door access code is authorized.

5. The access control system of claim 1, further comprising:
a door interior sensor for detecting a user in close proximity to the door interior sensor, detecting if there is a powered secure card presently with the user, and notifying the user that the user does not presently have a powered secure card.

6. The access control system of claim 5, the door interior sensor controlling a door to remain unlocked after notifying the user that the user does not have a powered secure card.

7. The access control system of claim 1, the powered secure card further comprising:
a wireless transceiver for communicating with wireless transceivers in sensors.

8. An access control system and method comprising:
detecting a powered secure card by an elevator exterior sensor;
reading, by the elevator exterior sensor, an elevator access code stored in the powered secure card;
summoning, by the elevator exterior sensor, an elevator if the elevator access code authorizes a user of the power secure card to use the elevator;
reading, by an elevator interior sensor, a floor access code stored in the powered secure card; and
traveling, by the elevator, to a floor of a building represented by the floor access code if the floor access code is authorized.

9. The access control system and method of claim 8, further comprising:
detecting a powered secure card by a door exterior sensor;
reading, by the door exterior sensor, the door access code from the powered secure card; and
instructing, by the door exterior sensor, a door controlled by the door exterior sensor to unlock if the door access code is authorized.

10. The access control system and method of claim 8, further comprising:
detecting, by a door interior sensor, a user in close proximity to the door interior sensor;
detecting, by the door interior sensor, if there is a powered secure card presently with the user; and
notifying, by the door interior sensor, the user that the user does not presently have a powered secure card.

11. The access control system and method of claim 10, further comprising:
controlling, by the door interior sensor, the door to remain unlocked after notifying the user that the user does not presently have a powered secure card.

12. The access control system and method of claim 8, further comprising prior to reading the elevator access code:
requesting, by the elevator exterior sensor, to read an elevator access code stored in the powered secure card;
determining, by the powered secure card, if the elevator exterior sensor has authorization to read the elevator access code; and
allowing, by the powered secure card, the elevator exterior sensor to read the elevator access code if the elevator exterior sensor has authorization to read the elevator access code.

13. The access control system and method of claim 8, further comprising prior to reading the floor access code:
requesting, by the elevator interior sensor, to read a floor access code stored in the powered secure card;
determining, by the powered secure card, if the elevator interior sensor has authorization to read the floor access code; and
allowing, by the powered secure card, the elevator interior sensor to read the floor access code if the elevator interior sensor has authorization to read the floor access code.

14. The access control system and method of claim 8, further comprising:
detecting, by the elevator interior sensor prior to reading the floor access code, how many occupants are in the elevator.

15. The access control system and method of claim 14, further comprising:
determining, by the elevator interior sensor prior to reading the floor access code, if a number of occupants is more than a number of powered secure cards and if the number of occupants is more than the number of powered secure cards instructing the elevator to remain stationary.

16. The access control system and method of claim 8, where the elevator interior sensor and the elevator exterior sensor both comprise wireless transceivers for communicating with a wireless transceiver in the powered secure card.

17. An access control system and method comprising:
detecting a powered secure card by an elevator exterior sensor;
requesting, by the elevator exterior sensor, to read an elevator access code stored in the powered secure card;
determining, by the powered secure card, if the elevator exterior sensor has authorization to read the elevator access code;
allowing, by the powered secure card, the elevator exterior sensor to read the elevator access code if the elevator exterior sensor has authorization to read the elevator access code;
reading, by the elevator exterior sensor, the elevator access code from the powered secure card;
summoning, by the elevator exterior sensor, an elevator car if the elevator access code authorizes a user of the powered secure card to use the elevator;
detecting a powered secure card by an elevator interior sensor;
requesting, by the elevator interior sensor, to read a floor access code stored in the powered secure card;
determining, by the powered secure card, if the elevator interior sensor has authorization to read the floor access code;
allowing, by the powered secure card, the elevator interior sensor to read the floor access code if the elevator interior sensor has authorization to read the floor access code;
reading, by the elevator interior sensor, the floor access code from the powered secure card; and
instructing, by the elevator interior sensor, the elevator car to travel to a floor of a building represented by the floor access code.

18. The access control system and method of claim 17, further comprising:
detecting, by the elevator interior sensor, how many occupants are in the elevator prior to requesting to read the floor access code stored in the powered secure card.

19. The access control system and method of claim 18, further comprising:
determining, by the elevator interior sensor, if a number of occupants is more than a number of powered secure cards and if the number of occupants is more than the number of powered secure cards instructing the elevator to remain stationary.

20. The access control system and method of claim 17, further comprising:
detecting a powered secure card by a door exterior sensor;
requesting, by the door exterior sensor, to read a door access code stored in the powered secure card;
determining, by the powered secure card, if the door exterior sensor has authorization to read the door access code;
allowing, by the powered secure card, the door exterior sensor to read the door access code if the door exterior sensor has authorization to read the door access code;
reading, by the door exterior sensor, the door access code from the powered secure card; and
instructing, by the door exterior sensor, a door controlled by the door exterior sensor to unlock if the door access code is authorized.

21. The access control system and method of claim 17, further comprising:
detecting, by a door interior sensor, a user in close proximity to the door interior sensor;
detecting, by the door interior sensor, if there is a powered secure card presently with the user; and
notifying, by the door interior sensor, the user that the user does not presently have a powered secure card.

22. The access control system and method of claim 21, further comprising:
controlling, by the door interior sensor, the door to remain unlocked after notifying the user that the user does not presently have a powered secure card.
